(19) United States
(12) Patent Application Publication
(10) Pub. No.: US 2025/0163316 A1
(43) Pub. Date: May 22, 2025

(54) OH GROUP-CONTAINING PHOSPHOR-FLUORESCENT MATERIAL INCLUDING VALLEYTRONICS MATERIAL AND FLUORESCENT ORGANIC MATERIAL

(71) Applicants: Research Business Foundation SUNGKYUNKWAN UNIVERSITY, Suwon-si (KR); The Regents of the University of Michigan, Ann Arbor, MI (US); Inha University Research and Business Foundation, Incheon (KR)

(72) Inventors: Sunkook KIM, Suwon-si (KR); Dong Hyuk PARK, Incheon (KR); Jinsang KIM, Ann Arbor, MI (US)

(73) Assignees: Research Business Foundation SUNGKYUNKWAN UNIVERSITY, Suwon-si (KR); The Regents of the University of Michigan, Ann Arbor, MI (US); Inha University Research and Business Foundation, Incheon (KR)

(21) Appl. No.: 18/512,555

(22) Filed: Nov. 17, 2023

(51) Int. Cl. C09K 11/06; C09K 11/02

(52) U.S. Cl. CPC C09K 11/06; C09K 11/02; C09K 2211/1011

(57) ABSTRACT

Provided are a phosphorescent material including a valleytronics material and a fluorescent organic material and having improved phosphorescent characteristics, and a method of producing the same. Phosphorescence technology may be used that allows a pure fluorescent organic material to produce pure organic phosphorescence by using a magnetic field derived from a valleytronics material via a low-cost and simple eco-friendly process. In addition, it is possible to produce micro-second phosphorescence simply through the presence or absence of a valleytronics material without heavy metal substitution of a pure organic material, color control is possible, and the process is simple and safe because the process is based on a room-temperature solution process.

### BACKGROUND OF THE INVENTION

### Field of the Invention

The present invention relates to an OH group-containing phosphor-fluorescent material including a valleytronics material and a fluorescent organic material, and more particularly, to a technology for producing pure organic phosphorescence by placing a pure fluorescent organic material on a valleytronics material and using a magnetic field derived from the valleytronics material.

### Description of the Related Art

Organic light-emitting diodes (OLEDs) are semiconductor devices that convert electrical energy into light energy to emit light by themselves, and are self-emissive devices that emit light by electrically exciting organic light-emitting materials. Based on many advantages such as short response times, low driving voltage, low power consumption, and high luminescence efficiency, OLEDs have been receiving a lot of attention as next-generation displays after LCDs.

Such an OLED includes a substrate, a cathode, an anode, and a light-emitting material layer formed between the anode and the cathode. The principle is that when a voltage is applied to an organic light-emitting device, electrons and holes injected through a cathode and an anode recombine in an organic-material thin film to produce molecular excitons, and the molecular excitons fall to the ground state, thereby emitting visible light corresponding to an energy gap of a material for an emission layer. At this time, depending on how the emission layer is formed, blue, green, and red light emitting devices may be implemented.

Singlet excitation and triplet excitation are known as excited states, and it is considered that light emission is possible through either of the excited states. In order to improve characteristics of organic light-emitting devices, improvements in device structures and development of materials have been made. Recently, it has been revealed that not only fluorescent materials but also phosphorescent materials may be used in organic light-emitting devices, and thus, such phosphorescent materials have been receiving attention.

Phosphorescence is a light-emitting mechanism having a long light-emitting lifespan and high quantum efficiency, and is used as a core technology for OLEDs. To date, the heavy-atom effect, which causes a change in the spin state of electrons by substituting heavy metals, including iridium, platinum, and osmium, into a molecule, has been mainly used to produce phosphorescence. However, such a method has limitations such as having a high cost per unit and being a complex and toxic process.

According to the prior art (Registration no. 10-1844879), as a method of forming an organic electron layer having an organic emitter that is phosphorescent at room temperature, an organic fluorescent emitter is deposited simultaneously with an organic complex ligand-containing metal complex and a heavy metal, including In, Ti, Sn, Pb, Sb, and Bi, in one layer to produce phosphorescence. This has the limitation of being a complex and toxic process during which the heavy-atom effect, which causes a change in the spin state of electrons, occurs.

### SUMMARY OF THE INVENTION

A technical object to be achieved by the present invention is to provide a phosphorescent material and phosphorescence technology capable of allowing a pure fluorescent organic material to produce pure organic phosphorescence by using a magnetic field derived from a valleytronics material via a low-cost and simple eco-friendly process.

The technical object to be achieved by the present invention is not limited to the above-described technical object, and other technical objects that are not mentioned will be clearly understood by those of ordinary skilled in the art from the following description.

In order to achieve the technical object, an embodiment of the present invention provides an OH group-containing phosphor-fluorescent material including a valleytronics material and a fluorescent organic material disposed on the valleytronics material.

In an embodiment of the present invention, the valleytronics material may be one selected from the group consisting of graphene, few-layer phosphorene, transition metal dichalcogenide monolayers, diamond, bismuth, silicon, carbon nanotubes, aluminium arsenide, and silicene.

In an embodiment of the present invention, a phosphorescent material including the fluorescent organic material may produce pure organic phosphorescence due to the Zeeman effect of the valleytronics material.

In order to achieve the technical object, another embodiment of the present invention provides an OH group-containing phosphor-fluorescent material including a valleytronics material and a phosphorescent organic material disposed on the valleytronics material.

In an embodiment of the present invention, the valleytronics material may be one selected from the group consisting of graphene, few-layer phosphorene, transition metal dichalcogenide monolayers, diamond, bismuth, silicon, carbon nanotubes, aluminium arsenide, and silicene.

In an embodiment of the present invention, the OH group-containing phosphor-fluorescent material may have improved phosphorescent characteristics due to the Zeeman effect of the valleytronics material.

In order to achieve the technical object, another embodiment of the present invention provides a method of producing a phosphorescent material, the method including preparing a valleytronics material, preparing a fluorescent organic material, producing a solution by dissolving the fluorescent organic material in an organic solvent, and forming a layered structure with the solution on the valleytronics material.

In an embodiment of the present invention, the valleytronics material may be one selected from the group consisting of graphene, few-layer phosphorene, transition metal dichalcogenide monolayers, diamond, bismuth, silicon, carbon nanotubes, aluminium arsenide, and silicene.

In an embodiment of the present invention, the forming of the layered structure may include activating triplet by controlling an electron spin state.

According to an embodiment of the present invention, phosphorescence technology may be used that is capable of allowing a pure fluorescent organic material to produce pure organic phosphorescence by using a magnetic field derived from a valleytronics material via a low-cost and simple eco-friendly process.

In addition, it is possible to produce micro-second phosphorescence simply through the presence or absence of a valleytronics material without heavy metal substitution of a pure organic material, color control is possible, and the process is simple and safe because the process is based on a room-temperature solution process.

The effects of the present invention are not limited to the above-described effects, and it should be understood that the effects include all effects that can be inferred from the configuration of the invention described in the detailed description of the invention or the claims.

### BRIEF DESCRIPTION OF THE DRAWINGS

FIG. 1 is an image showing the Zeeman effect in which the spin energy of an electron is split by an external magnetic field.

FIG. 2 is an image showing a spin valley coupling phenomenon in which the energy of Ev is split at a K point due to the structural inversion symmetry of a two-dimensional nanomaterial.

FIG. 3A to FIG. 3D are images showing a spin valley coupling phenomenon in which the energy of Ev is split at a K point due to the structural inversion symmetry of a two-dimensional nanomaterial.

FIG. 4A to FIG. 4E are images showing a spin valley coupling phenomenon in which the energy of Ev is split at a K point due to the structural inversion symmetry of a two-dimensional nanomaterial.

FIG. 5A is a graph showing light energy emission according to a wavelength and, and FIG. 5B is a graph showing light energy emission according to a time, in the case of diethyl 2, 5-dihydroxyterephthalate (DDT) which is a pure organic material.

FIG. 6A to FIG. 6E are images in which a transition metal chalcogen compound and a fluorescent organic material are stacked to produce organic phosphorescence.

FIG. 7 is an image in which RGB is implemented through a combination of various transition metal chalcogen compounds and fluorescent organic materials.

### DETAILED DESCRIPTION OF THE INVENTION

In the following description, the present invention is described with reference to the accompanying drawings. However, the present invention may be implemented in various forms, and thus, is not limited to embodiments described herein. In addition, irrelevant descriptions are omitted to clearly explain the present invention, and throughout the specification, the same or corresponding elements are indicated by the same reference numerals.

Throughout the specification, when a portion is connected (accessed, contacted, or coupled) with other portions, it includes direct connection as well as indirect connection in which the other member is positioned therebetween. Furthermore, throughout the specification, when a portion “includes” an element, another element may be further included, rather than excluding the existence of the other element, unless otherwise described.

The terms used in the present specification are merely used to describe particular embodiments, and are not intended to limit the present invention. The expression of singularity in the specification includes the expression of plurality unless clearly specified otherwise in context. In the present specification, it is to be understood that the terms such as “including,” “having,” and “comprising” are intended to indicate the existence of the features, numbers, steps, actions, elements, parts, or combinations thereof disclosed in the specification, and are not intended to preclude the possibility that one or more other features, numbers, steps, actions, elements, parts, or combinations thereof may exist or may be added.

Hereinafter, an embodiment of the present invention is described in detail with reference to the accompanying drawings.

An OH group-containing phosphor-fluorescent material according to an embodiment of the present invention is described.

An OH group-containing phosphor-fluorescent material according to an embodiment of the present invention may include a valleytronics material and a fluorescent organic material disposed on the valleytronics material.

The valleytronics material may be one selected from the group consisting of graphene, few-layer phosphorene, transition metal dichalcogenide monolayers, diamond, bismuth, silicon, carbon nanotubes, aluminium arsenide, and silicene.

In the present invention, as the valleytronics material, molybdenum disulfide (MoS₂) which is a transition metal chalcogen compound is used, and as the fluorescent organic material, diethyl 2, 5-dihydroxyterephthalate (DDT) is used.

A phosphorescent material including the fluorescent organic material may produce pure organic phosphorescence due to the Zeeman effect of the valleytronics material. In physics, the Zeeman effect is a phenomenon in which part of the emission spectral line of an atom or molecule is split into several lines due to an external magnetic field. In the present invention, a pure fluorescent organic material is used to produce pure organic phosphorescence by using a magnetic field derived from a valleytronics material, and great progress has resulted in phosphorescence technology that may be used via a low-cost and simple eco-friendly process.

Hereinafter, an OH group-containing phosphor-fluorescent material according to another embodiment of the present invention is described.

An OH group-containing phosphor-fluorescent material according to an embodiment of the present invention may include a phosphorescent material having improved phosphorescent characteristics due to a valleytronics material.

The valleytronics material may be one selected from the group consisting of graphene, few-layer phosphorene, transition metal dichalcogenide monolayers, diamond, bismuth, silicon, carbon nanotubes, aluminium arsenide, and silicene.

The phosphorescent material may have improved phosphorescent characteristics due to the Zeeman effect of the valleytronics material.

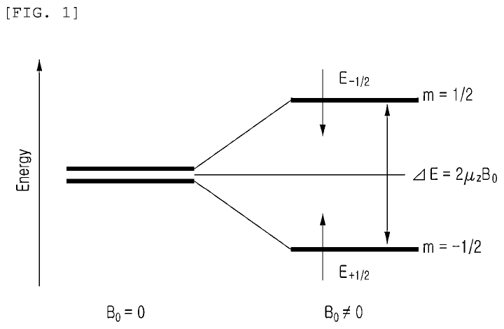

FIG. 1 is an image showing the Zeeman effect in which the spin energy of an electron is split by an external magnetic field.

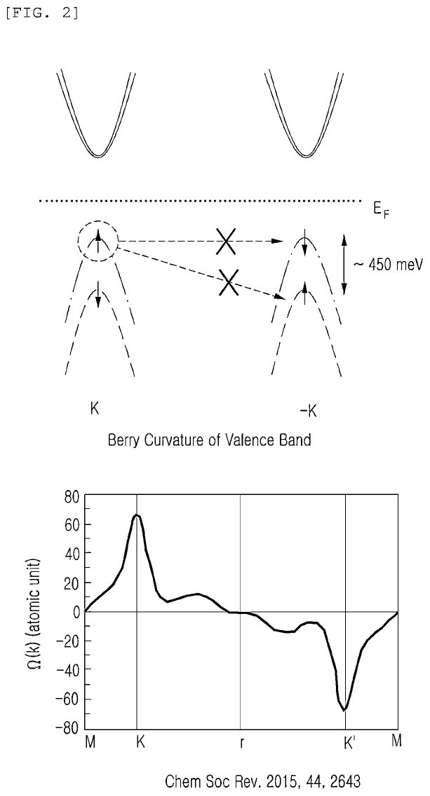

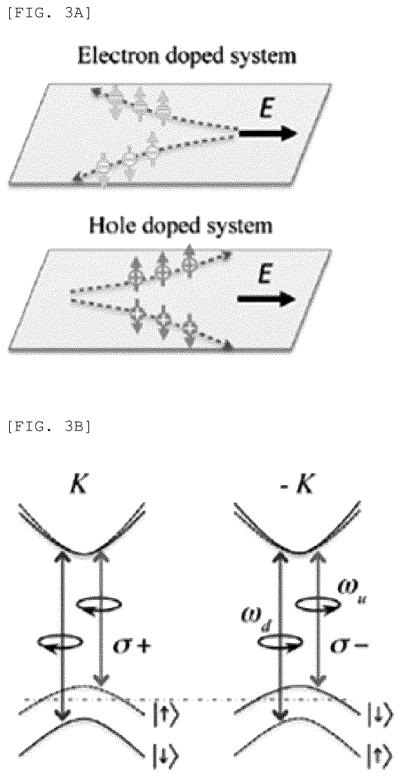

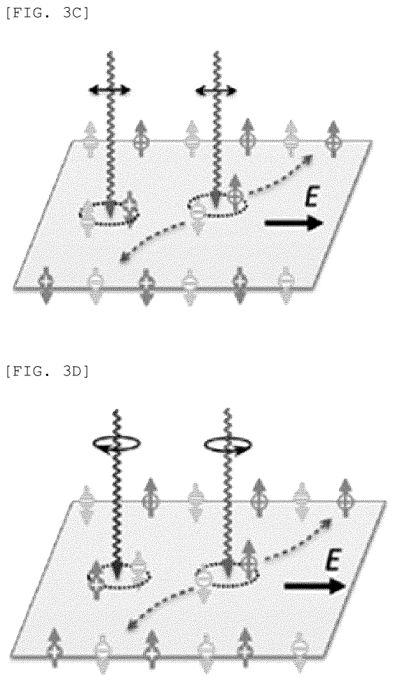

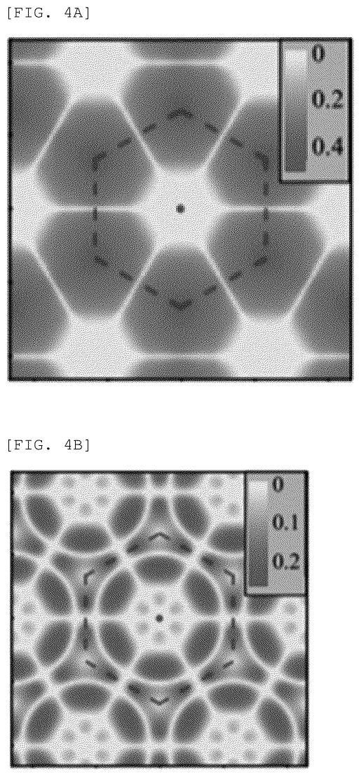

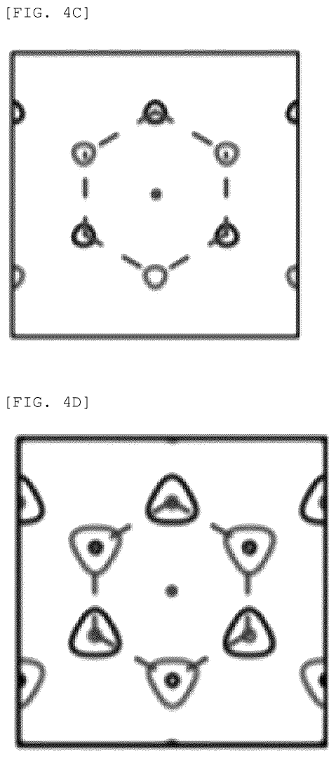

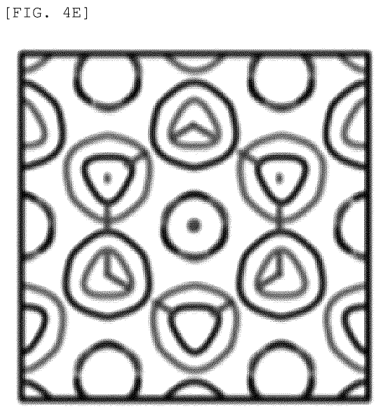

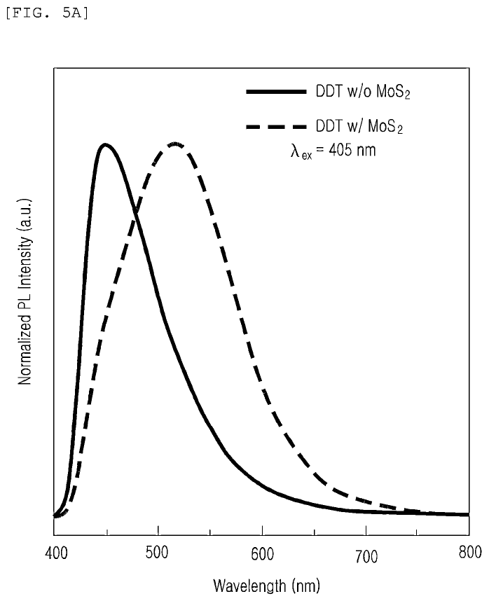

FIGS. 2 to 4E are images showing a spin valley coupling phenomenon in which the energy of Ev is split at a K point due to the structural inversion symmetry of a two-dimensional (2D) nanomaterial.

Referring to FIGS. 1 to 4E, the Zeeman effect is an effect in which the spin energy of an electron is split by an external magnetic field. Most atoms have different atomic orbitals having the same energy, but even when a transition to another atomic orbital occurs, only one spectral line may appear. At this time, when a magnetic field is applied, the energy of each atomic orbital is changed by the magnetic field that affects each electron differently depending on the quantum number, and then the different atomic orbitals that had the same energy have different energies. A distance between spectral lines separated by the Zeeman effect is proportional to the strength of the magnetic field.

Spin and valley indices of charge carriers are coupled in 2D transition metal dichalcogenide monolayers in connection with a spin valley coupling phenomenon. A spin valley coupling phenomenon occurs in which the energy of Ev is split at a K point due to the structural inversion symmetry of a 2D nanomaterial.

Hereinafter, a method of producing an OH group-containing phosphor-fluorescent material according to another embodiment of the present invention is described.

A method of producing an OH group-containing phosphor-fluorescent material according to an embodiment of the present invention may include preparing a valleytronics material, preparing a fluorescent organic material, producing a solution by dissolving the fluorescent organic material in an organic solvent, and forming a layered structure with the solution on the valleytronics material.

The first step is to prepare a valleytronics material. The valleytronics material may be one selected from the group consisting of graphene, few-layer phosphorene, transition metal dichalcogenide monolayers, diamond, bismuth, silicon, carbon nanotubes, aluminium arsenide, and silicene. In the present invention, as the valleytronics material, molybdenum disulfide (MoS₂) which is a transition metal chalcogen compound is used.

The next step is to prepare a fluorescent organic material, and in the present invention, diethyl 2, 5-dihydroxyterephthalate (DDT) which is a pure organic material is used.

The next step is to produce a solution by dissolving the fluorescent organic material in an organic solvent, and the organic solvent may include tetrahydrofuran (THF) or dimethylformamide (DMF).

The last step is to form a layered structure with the solution on the valleytronics material. The forming of the layered structure may include forming the layered structure by drop casting and activating triplet by controlling an electron spin state.

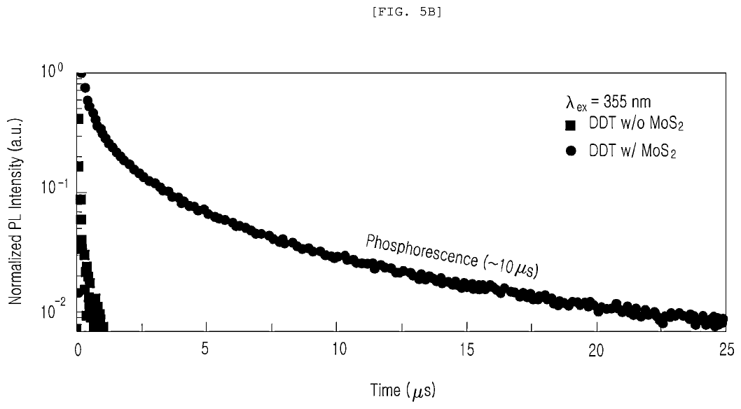

FIG. 5A is a graph showing light energy emission according to a wavelength and, and FIG. 5B is a graph showing light energy emission according to a time, in the case of diethyl 2, 5-dihydroxyterephthalate (DDT) which is a pure organic material.

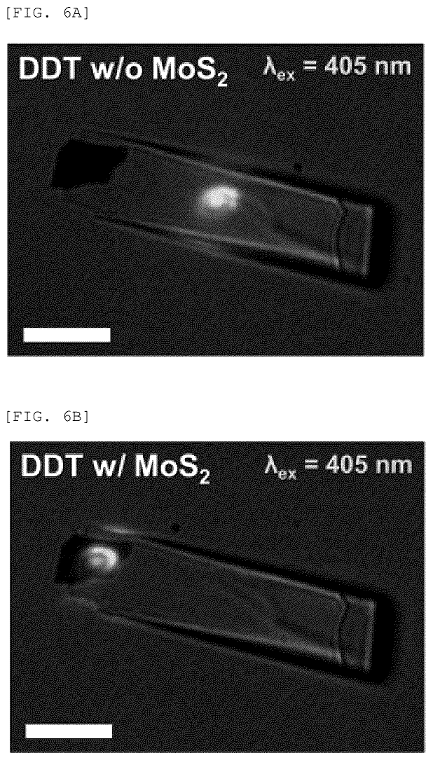

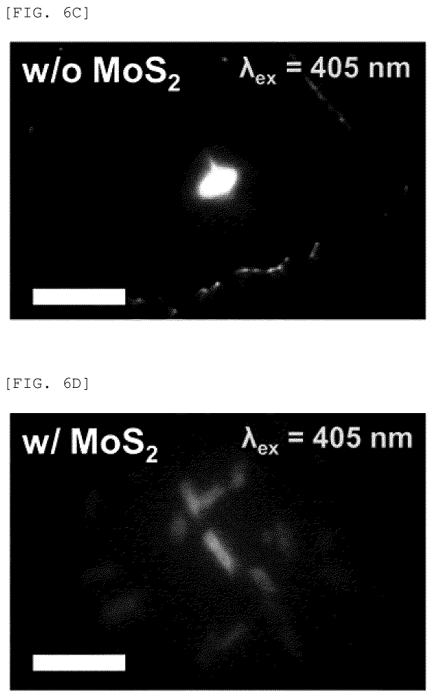

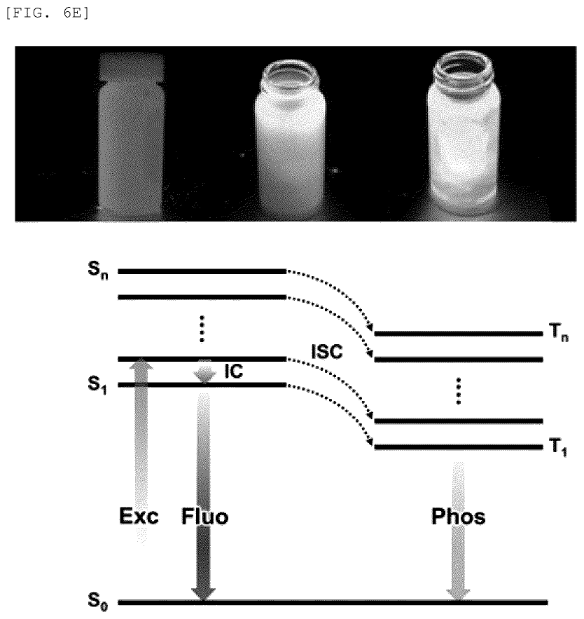

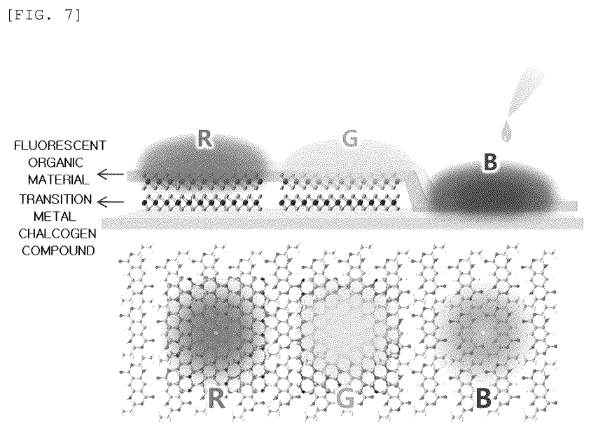

FIG. 6A to FIG. 6E are images in which a transition metal chalcogen compound and a fluorescent organic material are stacked to produce organic phosphorescence.

FIG. 7 is an image in which RGB is implemented through a combination of various transition metal chalcogen compounds and fluorescent organic materials.

Referring to FIGS. 5A, 5B to 7, diethyl 2, 5-dihydroxyterephthalate (DDT), which is a pure organic material, exhibits maximum emission at 450 nm when existing alone and emits blue fluorescence having a lifespan of several ns. However, when diethyl 2, 5-dihydroxyterephthalate (DDT) is disposed on top of molybdenum disulfide (MoS₂) which is a valleytronics material, maximum emission shifts to 516 nm, resulting in a change in color to green and an increase in lifespan to tens of μs. It may be confirmed that the presence of MoS₂, which is a valleytronics material, causes a change in color of DDT and pure organic phosphorescence. Such an effect is not limited to DDT which is a fluorescent organic material, but it may be confirmed that a valleytronics material may interact with other organic materials.

The above description of the present invention is for illustration, and those of ordinary skill in the art to which the present invention pertains can understand that it can be easily modified into other specific forms without changing the technical spirit or essential features of the present invention. Therefore, it should be understood that the embodiments described above are illustrative in all respects and not restrictive. For example, each element described as a single type may be implemented in a distributed form, and likewise elements described as distributed may be implemented in a combined form.

The scope of the present invention is indicated by the following claims, and all changes or modifications derived from the meaning and scope of the claims and their equivalents should be construed as being included in the scope of the present invention.

What is claimed is:

1. An OH group-containing phosphor-fluorescent material comprising:
a valleytronics material; and
a fluorescent organic material disposed on the valleytronics material.

2. The OH group-containing phosphor-fluorescent material of claim 1, wherein the valleytronics material is one selected from the group consisting of graphene, few-layer phosphorene, transition metal dichalcogenide monolayers, diamond, bismuth, silicon, carbon nanotubes, aluminium arsenide, and silicene.

3. The OH group-containing phosphor-fluorescent material of claim 1, wherein pure organic phosphorescence is produced due to a Zeeman effect of the valleytronics material.

4. An OH group-containing phosphor-fluorescent material comprising:
a valleytronics material; and
a phosphorescent organic material disposed on the valleytronics material.

5. The OH group-containing phosphor-fluorescent material of claim 4, wherein the valleytronics material is one selected from the group consisting of graphene, few-layer phosphorene, transition metal dichalcogenide monolayers, diamond, bismuth, silicon, carbon nanotubes, aluminium arsenide, and silicene.

6. The OH group-containing phosphor-fluorescent material of claim 4, wherein phosphorescent characteristics are improved due to a Zeeman effect of the valleytronics material.

7. A method of producing an OH group-containing phosphor-fluorescent material, the method comprising:
preparing a valleytronics material;
preparing a fluorescent organic material;
producing a solution by dissolving the fluorescent organic material in an organic solvent; and
forming a layered structure with the solution on the valleytronics material.

8. The method of claim 7, wherein the valleytronics material is one selected from the group consisting of graphene, few-layer phosphorene, transition metal dichalcogenide monolayers, diamond, bismuth, silicon, carbon nanotubes, aluminium arsenide, and silicene.

9. The method of claim 7, wherein the forming of the layered structure comprises activating triplet by controlling an electron spin state.
